(19) United States
(12) Patent Application Publication
(10) Pub. No.: US 2005/0189444 A1
(43) Pub. Date: Sep. 1, 2005

(54) Wireless control system for a spreader

(75) Inventor: James A. Kost, Cleveland, OH (US)

Correspondence Address: BROUSE MCDOWELL, 388 SOUTH MAIN STREET, SUITE 500, AKRON, OH, 44311-4407, US

(73) Assignee: MEYER PRODUCTS, INC.

(21) Appl. No.: 11/069,072

(22) Filed: Mar. 1, 2005

Related U.S. Application Data
(60) Provisional application No. 60/549,110, filed on Mar. 1, 2004.

(51) Int. Cl. A01C 3/06

(52) U.S. Cl. 239/661; 700/17; 700/83; 340/825.72; 455/41.2

(57) ABSTRACT

A vehicle includes a vehicle spreader and a controller having a transmitter and a receiver. The transmitter and the receiver are wirelessly communicated to the send and receive wireless signals. The transmitter can send verification data to the receiver so as to communicate command signals to a specific receiver. The receiver is connected to control the actuation of the vehicle spreader.

This U.S. utility patent application claims priority from U.S. provisional patent application Ser. No. 60/549,110 filed on Mar. 1, 2004.

### I. BACKGROUND OF THE INVENTION

A. Field of Invention

The present invention relates to the art of automotive vehicle snow plows and accessories, such as a spreader and controls therefore, and more particularly to a transmitter adapted to provide a wireless signal to a spreader or other accessory to the receiver of such accessory.

B. Description of the Related Art

When a spreader is installed, mounted, or connected to a vehicle, the installation typically requires that controls mount within the vehicle, such as a series of switches, lights, and indicators. Currently, the various movements of functions of spreaders are controlled by running wires from the spreader to a set of switches mounted in the vehicle cab. Generally, switches may include controls for the motor, a material guide, the speed of the auger, a de-icer solution switch, and switches for the speed and direction of the spreader disk rotation. Of course, other switches for spreader functions are not uncommon. Electrical wiring must be run from the actuating means mounted on the vehicle which performs the various spreader movements and functions to the control means mounted within the vehicle cab. The electrical wires must pass through the vehicle's numerous obstacles before it is mounted in the vehicle cab. Between the vehicle and the spreader, the electrical wires may have a plug and receptacle so that the electrical wires can be disconnected when the spreader is removed. Typically, the electrical wires passing through the vehicle and switches within the vehicle cab remain permanently mounted within the vehicle. The present invention eliminates the electrical wires, plug-in receptacle, and permanent mounting of the switches by incorporating wireless remote control.

Based upon the foregoing, there is a need in the art to provide wireless remote control to a spreader from the inside of a vehicle.

The present invention provides methods and apparatuses for wireless controls for a spreader. The difficulties inherent in the art are therefore overcome in a way that is simple and efficient, while providing better and more advantages results.

### II. SUMMARY OF THE INVENTION

According to one aspect of the present invention, a new and improved wireless control system for a spreader is provided which comprises a receiver operatively connected to a spreader and a transmitter positioned in a vehicle, wherein said transmitter transmits a signal to the receiver and the receiver actuates a function of the spreader.

According to another aspect of the present invention, the wireless control system drives the hydraulic motor for a conveyor belt that turns the spreader to discharge material.

Another objective of the present invention is to provide a wireless control system for a spreader that controls the material guide of the spreader.

Still yet, another object of the present invention is to provide a wireless control system for a spreader, wherein the speed of the auger is controlled.

Further, another object of the present invention is to provide a wireless control system for a spreader which controls the amount of deicer solution added to the material dispensed by the spreader.

Still yet, another object of the present invention is to provide a wireless control for a spreader which controls the speed or direction of disk rotation to spread the material.

Further, another object of the present invention is to provide a control system for a spreader that is voice activated.

Still yet, another object of the present invention is to provide vehicle having a spreader and a spreader control, including a vehicle having a vehicle frame; at least a first ground engaging wheel rotatably connected with respect to the vehicle frame; an engine for use in providing locomotion to drive the vehicle, the engine being operatively received by the vehicle frame; at least a first electrical output means powered by the engine; a spreader operatively connected to the vehicle; and, an electrically powered control means operatively connected to control operation of the spreader, the control means having a transmitter and a receiver, wherein the transmitter wirelessly communicates with the receiver.

Still yet, another object of the present invention is to provide a vehicle including a hopper operatively connected to the vehicle frame for use in storing an associated material, the hopper having at least a first associated material output, wherein the associated material from the hopper is operatively communicated to the spreader.

Yet, another object of the present invention is to provide a transmitter that is a portable transmitter.

Still yet, another object of the present invention is to provide a transmitter that includes a self contained battery for use in providing power to the transmitter.

Yet, another object of the present invention is to provide a transmitter that includes a power cable for use in receiving electrical power from the at least a first electrical output to the transmitter.

Still yet, another object of the present invention is to provide a transmitter that includes at least a first joystick for use in controlling one or more functions of the spreader.

Yet, another object of the present invention is to provide a spreader that includes at least a first spreader actuator, and, wherein the receiver is electrically communicated to selectively activate the at least a first spreader actuator.

Still yet, another object of the present invention is to provide a transmitter that is operable to transmit a signal to the receiver, wherein the signal comprises at least a set of unique address information, and, wherein the receiver is operable to receive the signal from the transmitter and to activate the at least a first spreader actuator responsive to the set of unique address information.

Still yet, another object of the present invention is to provide a conveyor operatively connected to the hopper, the conveyor having a conveyor actuator.

Still yet, another object of the present invention is to provide a receiver that is operatively communicated to selectively activate the conveyor actuator responsive to the signal received by the transmitter.

Still yet, another object of the present invention is to provide a transmitter that includes voice recognition for use in receiving voice commands from an associated operator, and, wherein the transmitter is operable to translate the voice commands into wireless signals to be sent to the receiver.

Still yet, another object of the present invention is to provide a vehicle spreader, including a spreader frame; at least a first spreader disk rotatably connected to the spreader frame; a spreader actuator operatively connected to rotate the at least a first spreader disk; and, an electrically powered control means operatively connected to control operation of the spreader, the control means having a transmitter and a receiver, wherein the transmitter wirelessly communicates with the receiver.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a perspective view of a vehicle illustrating the present invention.

FIG. 2 is a perspective view of the present invention.

### IV. DESCRIPTION OF THE PREFERRED EMBODIMENT

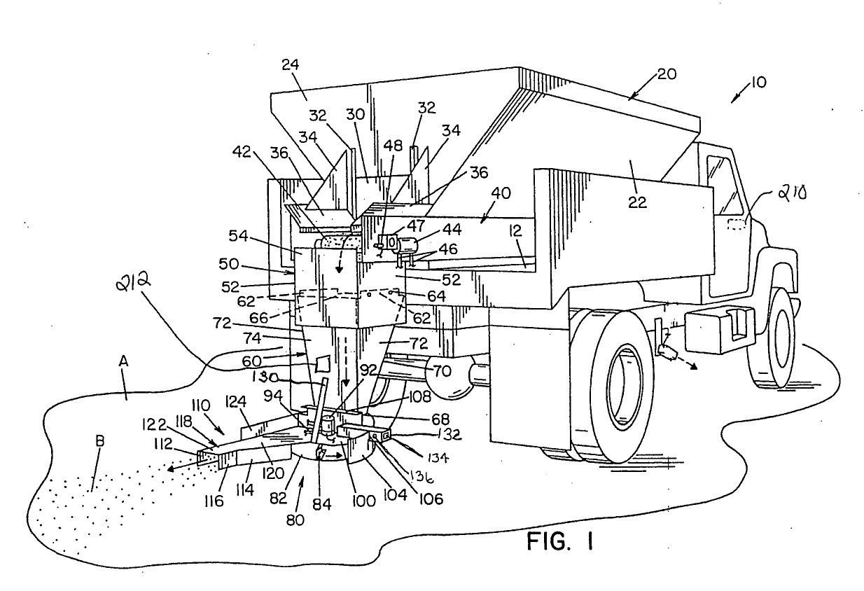

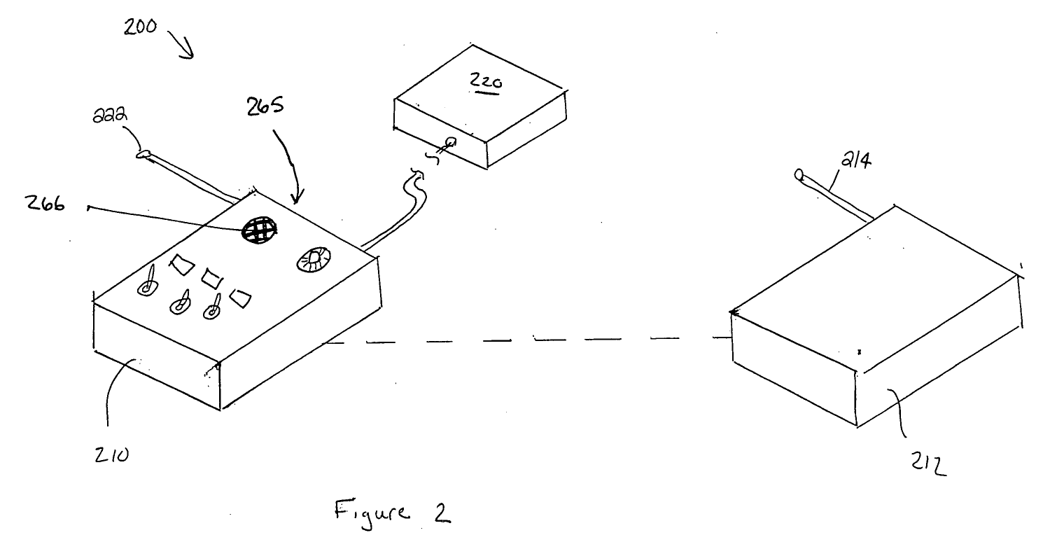

Referring now to the drawings wherein the showings are for purposes of illustrating a preferred embodiment of the invention only and not for purposes of limiting the same, FIGS. 1 and 2 show the present invention. The present invention comprises wireless spreader controls for controlling the movement and functions of a spreader mounted to a vehicle, such as a car or truck. The vehicle 3 may include a frame 4 and one or more ground engaging wheels 5 for use in providing mobility to the vehicle 3. The vehicle 3 may also include an engine 6, which may be an internal combustion engine 6. The engine 6 may include a means for generating electrical output power such as, but not limited to, an alternator 7. In one embodiment, the alternator 7 may provide electrical power output to drive one or more accessories of the vehicle, such as a spreader and/or a spreader controller to be described in detail in a subsequent paragraph.

While any spreader or spreader component may be utilized in conjunction with the present invention, a typical spreader will now be described. For example, spreaders manufactured and distributed by Swenson Spreader Company, an Ohio corporation, who has its principal place of business at Lindenwood, Ill., can be benefited from the present invention. These spreaders and spreader components include, but are not limited to, the EV Series, RTJ Series, S Series, MDV Series, MiniVee, PV Series, All Purpose Body 2, All Purpose Body, Liquid Spray System, and the Precision Placement Spinner.

FIG. 1 illustrates a conventional truck 10 having a hopper 20 mounted at the back end of the truck. The hopper 20 may be of any suitable type and, as illustrated herein, is of the V-box type which is adapted to receive particulate material B such as salt, sand, chemicals and/or cinders. Hopper 20 includes sides 22 sloping toward the base of the hopper. Mounted in the base of the hopper is a conveyor system 40 which is centrally located in the base of the hopper, preferably below the base plane of the hopper. The conveyor system 40 is adapted to transport particulate materials in the hopper toward an opening in the rear wall of the hopper. The conveyor system is in longitudinal alignment with the opening. The conveyor system includes a central longitudinally extending conveyor belt 42 integrated into the base of the hopper 20. The conveyor arrangement includes a front sprocket shaft and a rear sprocket shaft upon which conveyor belt 42 is rotated. The conveyor belt is shown to have a flat surface; however, the conveyor belt may include ribs to facilitate in the conveyance of particulate material. Alternatively, the conveyor belt may be a series of bar flights. A conveyor motor 44 is connected to the motor gearbox 47 which in turn drives the rear sprocket shaft to move the conveyor belt. A conveyor sensor 48 is connected to motor gearbox 47 to monitor the speed of rotation of conveyor belt 42. Conveyor motor 44 may be a hydraulically driven motor and includes two fluid lines 46 for supplying hydraulic fluid to drive the conveyor motor 44. Although not shown, the fluid lines are connected to a pump and a fluid reservoir. A valve may also be attached to the fluid lines 46 to control the flow of fluid to conveyor motor 44. Such a hydraulic arrangement is well known in the art and will not be further discussed The conveyor is illustrated as an endless type belt conveyor; however, it is contemplated that other types of conveyors could be used for delivering materials through the opening such as a screw type or auger conveyor.

Hopper 20 includes a feedgate 30 to adjust the size of the opening in rear wall 24 of hopper 20. Two gate rails 32 guide the feedgate and enable the feedgate to be moved upwardly and downwardly to control the size of opening. Although not shown, the feedgate is moved by a screw drive, hydraulic lift or pulley arrangement. Such arrangements for moving the feedgate are well known in the art and will not be further described herein.

With reference to FIG. 1, conveyor arrangement 40 extends through the opening and rearwardly from hopper rear wall 24. Side flanges 34 and guide plate 36 are connected to the back side of hopper rear wall 24 so as to direct particulate material which is flowing through rear wall opening back onto conveyor belt 42 so that substantially all the particulate material flowing through rear wall opening is deposited into top opening 66 of material bin 50. Material bin 50 includes two side walls 52 and a front wall 54. The side walls are mounted in one position to truck bed 12 of truck 10. Material bin 50 is mounted relative to conveyor 40 such that material bin 50 is positioned below the back end of conveyor 40 to receive substantially all the materials moving off conveyor belt 42. Front wall 54 of material bin 50 extends upwardly from side walls 52 so as to capture substantially all of the particulate material being conveyed off of conveyor belt 42.

A funnel receptacle 60 is connected to the inner side walls of material bin 50. Funnel receptacle 60 includes two side panels 72, a front panel 74 and a rear panel 70. Side panels 72 include a mount flange 62 adapted to mount side panels 72 to the interior of side walls 52 of material bin 50. Mount flanges 62 include mount openings 64 adapted to receive a connector for securing mount flange 62 to the side walls of material bin 50. Rear panel 70 is mounted on side panels 72 to slope toward front panel 74 to form a funnel receptacle having a wider top opening 66 than a bottom opening 68. In addition, one of the side panels 72 slopes inwardly toward the other side panel so that bottom opening 68 is narrower than top opening 66. The design of the funnel receptacle 60 is adapted to receive materials deposited into material bin 50 and to direct such materials into a specific location in material spreader 80 which is connected.

Material spreader 80 includes a disk 82 mounted onto a spreader motor 92. Spreader motor 92 is mounted onto spreader top plate 100. Disk 82 includes four disk vanes 84 which are mounted to the disk. The disk is preferably 18-30 inches in diameter and includes four vanes wherein each vane has a height of about 2-6 inches. More vanes can be used, but too many vanes may cause too much bounce as the particulate material is deposited onto ground surface A. The disk is mounted to be driven in a counterclockwise direction by a positive displacement type hydraulic spreader motor 92 to propel the particulate material to the right side of spreader 80. However, other spreader designs can be used which would require the spinner to rotate in a clockwise direction and propel the particulate material to the left side of spreader 80. Spreader motor 92 includes motor fluid lines 94 which supply hydraulic fluid for driving the motor which rotates disk 82. Although not shown, fluid lines 94 are connected to a pump and a fluid reservoir. A valve may also be attached to fluid lines 94 to control the flow of fluid to disk motor 92. Such a hydraulic arrangement is well known in the art and will not be further described herein.

With continuing reference to FIG. 1, connected to the top surface of top plate 100 is connector flange 108. Connector flange 108 connects the top plate of spreader 80 to the front panel 74 of funnel receptacle 60. Spreader 80 is further connected to funnel receptacle 60 by support bar 130. Support bar 130 helps to maintain spreader 80 in a substantially constant position relative to funnel receptacle 60. Spreader 80 also includes a side plate 104 which is connected to the edge of top plate 100. Side plate 104 extends above the surface of top plate 100 and extends below the surface of top plate 100 to at least the plane in which the disk rotates. Additionally, side plate 104 extends about the perimeter of disk 82 so as to create a retaining wall around the disk extending from the side of the disk around through the back of the disk to the other side of the disk. Side plate 104 is positioned closely adjacent to the disk so as to retain material deposited on the disk from funnel receptacle 60 until the disk has propelled such materials through the backside of material spreader 80. One function of side plate 104 is to direct the materials flowing through bottom opening 68 of funnel receptacle 60 onto the surface of disk 82.

A lift bar 132 is connected to top plate 100 and the side of connector flange 108 and extends through a side plate slot 106 of side plate 104. Lift bar 132 includes a lift bar opening positioned longitudinally through lift bar 132. Lift bar 132 is adapted to receive a bar connected to after so that material spreader 80 and funnel receptacle 60 can be easily positioned into material bin 50 to connect the material spreader and funnel receptacle to the material bin or alternatively, to disengage the funnel receptacle and material spreader from the material bin. Connector hole 136 is adapted to secure the lift rod which is inserted into lift bar opening 134 when the material spreader and funnel receptacle are being connected and/or engaged from material bin 50.

Connected to the top plate 100 and side plate 104 of material spreader 80 is material guide 110. Material guide 110 is positioned above ground surface A and lies in a plane substantially parallel to the ground surface. The bottom edge of the material guider is positioned at a sufficiently close distance to the ground to minimize the width of the strip or swath of particulate material being deposited on the ground surface by the material guide. Preferably, the material guide is spaced less than 24 inches from the ground surface and more preferably 2 to 14 inches from the ground surface. Material guide 110 includes a planar guide side 112 which is connected to one end of side plate 104 and to the top side edge of top plate 100. Planar guide side 112 is a one-piece planar extension of side plate 104 which extends rearwardly from the truck when material spreader 80 and funnel receptacle 60 are mounted to material bin 50. Planar guide side 112 includes a reinforcement flange 124 extending above the surface of top plate 100. Reinforcement flange 124 is designed to rigidify the position of the material guide 110 with respect to material spreader 80. Reinforcement flange 124 is an upward extension of planar guide side 112. Material guide 110 also includes a top plate 118. Top plate 118 includes a rectangular section 122 and an angular section 120. Top plate 118 is connected to top plate 100 of material spreader 80 and lies in a plane substantially the same as the plane in which top plane 100 lies. Top plate 118 and top plate 100 are a one-piece unit. Rectangular section 122 of top plate 118 is positioned at the end of material guide 110 and is connected to planar guide side 112 and parallel guide side 116. Angular section 120 of top plate 118 is connected to rectangular section 122 and lies in substantially the same plane as rectangular section 122. Angular section 120 is also connected to angular guide side 114 and planar guide side 112. This design of material guide 110 forms a wide passageway opening positioned closely adjacent to disk 82 which passageway narrows until reaching the passageway formed between planar guide side 112 and parallel guide side 116.

With reference to FIG. 2, the wireless spreader controls 200 include a transmitter 210 and a receiver 212. In one embodiment, the transmitter 210 may include a central processing unit, not shown. The central processing unit may be programmable as desired to affect operation of the transmitter 210. The transmitter 210 may be adapted to transmit radio signals, whereas the receiver 212 is adapted to receive radio signals. The transmitter 210 may be portable and can be operated from any location provided it is still within a predetermined transmitting range with respect to the receiver 212. The receiver 212 may be permanently mounted to the spreader, or it may be movable. The receiver 212 receives the radio signals from the transmitter 210 and then activates the various functions of the spreader, such as but not limited to activating a conveyor motor (hydraulic driven motor) for the conveyor belt that turns the spreader to discharge the material; controlling the material guide; controlling the speed of the auger; controlling the amount of de-icer solution utilized in conjunction with the material; and controlling the speed and direction of disk rotation.

With reference to FIGS. 1 and 2, the receiver 212 may be mounted to the spreader but could also be mounted anywhere on or within the vehicle 10. The receiver 212 may include an antenna 214 to aid in receiving the spreader control radio signals sent by the transmitter 210. The receiver 212 has an input wiring harness which includes electrical wires for obtaining power from the vehicle 70 and an output wiring harness for actuating the various spreader components.

The transmitter 210 may be a portable unit that can be located by the operator of the spreader in any desirable location. This includes within the cab of the vehicle 10 as shown in FIG. 1 or at a location outside of the vehicle cab. The only limitation regarding the location of transmitter 210 is that it must be located within a predetermined range of receiver 212 so that the signals transmitted can reach the receiver. Any transmitter chosen in accordance with sound engineering judgment may be utilized. It is also contemplated to be within the scope of the present invention that the actuation of the controls for the transmitter may be through voice activation. It this embodiment, the transmitter may include a voice recognition circuit 265 and/or algorithm. The transmitter may process voice commands as received via a microphone 266 and translate the signal into wireless commands to be sent to the receiver. What is important is that the transmitter is able to communicate with its associated receiver. The transmitter 210 sends unique address information to the receiver. This address information is set so that no two devices will be the same. There may be no limit to the number of wireless spreader controls used in the same vicinity without any cross-activation.

With reference to FIG. 2, the transmitter 210 requires a power supply 220. The power supply 220 can be a separate battery pack, a battery pack located within the housing of the transmitter 210, or the transmitter 210 can obtain its power directly from the vehicle's power source. For example, power supply wires could be adapted to be plugged into the cigarette lighter of vehicle. The transmitter 210 may include an antenna 222, for purposes of aiding in the transmission of spreader control radio signals to receiver 212 and may have a plurality of joystick switches and toggle switches for controlling the movements and functions of the spreader. Because the transmitter 210 may be completely portable, the operator can position the transmitter 210 in any desired location, including a location exterior to the vehicle cab. By portable it is meant that the transmitter may not be fixedly attached to the vehicle, but may be hand held and transported by the operator as desired. This is advantageous because often times, the operator may be required to make adjustments to the spreader.

Any receiver 212 chosen in accordance with sound engineering judgment may be utilized in conjunction with the foregoing invention. The receiver 212 should be able to receive the radio signal transmitted by the transmitter 210, decode the data stream and check for validity of the address and the start and stop bits of the received data. If this is correct, a software algorithm is performed to accept or reject the information to be passed on to the receivers outputs. If for any reason this test fails, no output will be sent from receiver 212. Once this test has passed, the appropriate output will be sent. The output activates one of the spreader mechanisms so that the spreader can operate.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

Having thus described the invention, it is now claimed:

1. A vehicle having a spreader and a spreader control, comprising:
a vehicle, including:
a vehicle frame;
at least a first ground engaging wheel rotatably connected with respect to the vehicle frame;
an engine for use in providing locomotion to drive the vehicle, the engine being operatively received by the vehicle frame;
at least a first electrical output means powered by the engine;
a spreader operatively connected to the vehicle; and,
an electrically powered control means operatively connected to control operation of the spreader, the control means having a transmitter and a receiver, wherein the transmitter wirelessly communicates with the receiver.

2. The vehicle of claim 1, further comprising:
a hopper operatively connected to the vehicle frame for use in storing an associated material, the hopper having at least a first associated material output, wherein the associated material from the hopper is operatively communicated to the spreader.

3. The vehicle of claim 2, wherein the transmitter is a portable transmitter.

4. The vehicle of claim 3, wherein the transmitter includes a self contained battery for use in providing power to the transmitter.

5. The vehicle of claim 3, wherein the transmitter includes a power cable for use in transmitting electrical power from the at least a first electrical output to the transmitter.

6. The vehicle of claim 5, wherein the transmitter includes at least a first joystick for use in controlling one or more functions of the spreader.

7. The vehicle of claim 6, wherein the spreader further comprises:
at least a first spreader actuator, and,
wherein the receiver is electrically communicated to selectively activate the at least a first spreader actuator.

8. The vehicle of claim 7, wherein the transmitter is operable to transmit a signal to the receiver, wherein the signal comprises unique address information, and,
wherein the receiver is operable to receive the signal from the transmitter and to activate the at least a first spreader actuator responsive unique address information.

9. The vehicle of claim 8, further comprising:
a conveyor operatively connected to the hopper, the conveyor having a conveyor actuator.

10. The vehicle of claim 9, wherein the receiver is operatively communicated to selectively activate the conveyor actuator responsive to the signal received by the transmitter.

11. The vehicle of claim 10, wherein the transmitter further comprises:
voice recognition means for use in receiving voice commands from an associated operator, and,
wherein the transmitter is operable to translate the voice commands into wireless signals to be sent to the receiver.

12. A vehicle spreader, comprising:
a spreader frame;
at least a first spreader disk rotatably connected to the spreader frame;
a spreader actuator operatively connected to rotate the at least a first spreader disk; and,
an electrically powered control means operatively connected to control operation of the spreader, the control means having a transmitter and a receiver, wherein the transmitter wirelessly communicates with the receiver.

13. The vehicle spreader of claim 12, wherein the transmitter is a portable transmitter.

14. The vehicle spreader of claim 13, wherein the transmitter includes a self contained battery for use in providing power to the transmitter.

15. The vehicle spreader of claim 13, wherein the transmitter includes a power cable for use in receiving electrical power from an associated remote electrical power source.

16. The vehicle spreader of claim 15, wherein the spreader further comprises:
a conveyor having a conveyor actuator; and,
wherein the receiver is electrically communicated to selectively activate the conveyor actuator.

17. The vehicle spreader of claim 16, wherein the transmitter is operable to transmit a signal to the receiver, wherein the signal comprises unique address information, and,
wherein the receiver is operable to receive the signal from the transmitter and to activate the spreader actuator responsive to the unique address information.

18. The vehicle spreader of claim 17, wherein the transmitter further comprises:
voice recognition means for use in receiving voice commands from an associated operator, and,
wherein the transmitter is operable to translate the voice commands into wireless signals to be sent to the receiver.
